(19) United States
(12) Patent Application Publication
(10) Pub. No.: US 2026/0162393 A1
(43) Pub. Date: Jun. 11, 2026

(54) DATA READING SYSTEMS FOR CAPTURING IMAGE DATA FROM MULTIPLE FIELDS-OF-VIEW

(71) Applicant: Datalogic USA, Inc., Eugene, OR (US)

(72) Inventor: Dana Louderback, Eugene, OR (US)

(21) Appl. No.: 18/970,773

(22) Filed: Dec. 5, 2024

(51) Int. Cl. G06V 10/141; G06V 10/147; G06V 10/25

(52) U.S. Cl. CPC G06V 10/141; G06V 10/147; G06V 10/25

(57) ABSTRACT

The disclosure relates to a data reading system and methods of operation designed for optimizing and efficiently handling image-processing functionalities of the data reading system using a single-reader configuration. The data reading system includes a single data reader and various optical elements arranged within the house, where the optical elements are configured to alternate fields-of-view of the data reader through one or more scan windows for capturing image data of an item. In some arrangements, the data reading system is set to cycle between each field-of-view to optimize the image data capture process.

### BACKGROUND

The present disclosure relates generally to data reading systems, and more particularly, to such systems and related methods for capturing image data from multiple fields-of-view using a single data reader.

Data reading systems in general are used in a variety of settings for reading optical codes, capturing images of items, and acquiring other suitable data for processing items. In a retail environment, data reading systems may use image sensors (such as monochrome or color imagers) for reading UPC and other types of optical codes, such as barcodes, digital watermarks, etc., on grocery items or packages to identify and process the items during a checkout process. Some data reading systems are equipped with more advanced imaging technologies that can be used for item and produce recognition, item verification, and other security applications during the checkout process. In self-checkout systems, these advanced features may be particularly advantageous to ensure proper item processing and avoid or minimize losses from retail theft or inadvertent processing errors by customers.

Some conventional data reading systems include multiple data readers or imaging devices that may be used for accomplishing various data reading tasks. For example, a bioptic data reading system may include a horizontal scan window and a vertical scan window with one or more first imagers arranged for capturing image data through the horizontal scan window and one or more second imagers arranged for capturing image data through the vertical scan window. Another data reading system may include one or more monochrome imagers optimized for acquiring image data and decoding optical code and may also include one or more color imagers optimized for acquiring color image data for more advanced image analysis, such as for item recognition and security applications as described above.

While conventional data reading systems with multiple imagers as described above may be deployed successfully for data reading applications, a multiple-data reader configuration increases the complexity and cost of the overall data reading system. In addition, such conventional data reading systems increase manufacturing time because each imaging device requires a lens system that needs separate alignment and focal adjustments to ensure optimal operation. Accordingly, the inventor has identified a need for an improved data reading system designed for efficiently accomplishing data reading tasks using a single imaging device with streamlined optics to provide image data from multiple fields-of-view through one or more scan windows of the data reading system. Additional aspects and advantages of such systems will be apparent from the following detailed description of example embodiments, which proceed with reference to the accompanying drawings.

Understanding that the drawings depict only certain embodiments and are not, therefore, to be considered limiting in nature, these embodiments will be described and explained with additional specificity and detail with reference to the drawings.

### BRIEF DESCRIPTION OF THE DRAWINGS

FIG. 1 illustrates a data reading system for processing an item in accordance with one example embodiment.

FIG. 2 is a simplified block diagram illustrating components of a data reading system in accordance with one embodiment.

FIG. 3 is a schematic illustration of a conventional data reading system with a dual-reader configuration for obtaining image data from an item in accordance with one embodiment.

FIG. 4 is a schematic illustration of a dual-plane data reading system with a single-reader configuration for obtaining image data from an item through a first scan window in accordance with one embodiment.

FIG. 5 is a schematic illustration of the data reading system of FIG. 4 with a single-reader configuration for obtaining image data from an item through a second scan window in accordance with one embodiment.

FIG. 6 is a schematic illustration of a dual-plane data reading system with a single-reader configuration for obtaining image data from an item, the system including a digital micromirror device operable to alternate the reader's field-of-view through multiple scan windows in accordance with one embodiment.

FIG. 7 is a schematic illustration of a single-plane data reading system with a single-reader configuration for obtaining image data from an item, the system including a digital micromirror device operable to alternate the reader's field-of-view through one scan window in accordance with one embodiment.

FIGS. 8 and 9 are schematic illustrations of a single-plane data reading system with a single-reader configuration for obtaining image data from an item through one scan window in accordance with one embodiment.

FIG. 10 is a flowchart for a method of data reading using a data reading system with a single-reader configuration in accordance with one embodiment.

### DETAILED DESCRIPTION OF DISCLOSED EMBODIMENTS

With reference to the drawings, this section describes specific embodiments relating to a data reading system and its detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

With collective reference to the figures, the following disclosure generally relates to a data reading system, such as a self-checkout system or other suitable point-of-sale system, that may be used in a retail setting to complete a customer transaction for the purchase of various goods offered in a retail facility. The data reading system may include any suitable data reader configuration operable for capturing image data from an item and any suitable reading engine configuration for decoding the captured image data to identify the associated item and complete the transaction.

As mentioned previously and further described in detail below, conventional data reading systems typically include multiple imagers having fields-of-view extending through one or more scan windows to capture image data from items being passed through a read region of the data reading system viewed via the scan windows. The embodiments described herein with reference to the figures relate to an improved data reading system with efficient and optimized image processing capabilities that use a single data reader (e.g., a monochrome or color imager or other suitable device) to capture image data of the item as it passes by one or more scan windows. More particularly, the data reading system uses the same data reader configured to alternate between multiple fields-of-view to capture image data of an item via one or more scan windows.

Accordingly, one advantage of the disclosed data reading system is that it streamlines the overall design of the data reading system by using only a single data reader to achieve the desired data reading functionalities, which in turn minimizes complexity and cost of the data reading system. In addition, the use of a single data reader improves overall system performance because, in some embodiments, processing and decoding the target data may be accomplished using only a single image of the read region. Additional details of these and other embodiments of the data reading system and related methods are further discussed below with reference to the accompanying figures.

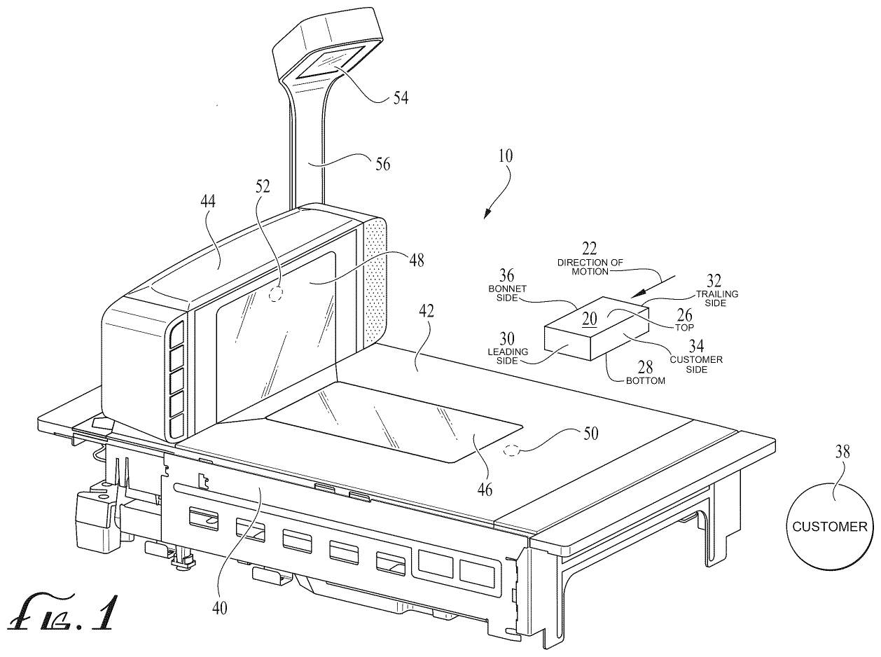

FIG. 1 illustrates an example embodiment of a data reading system 10 in accordance with one embodiment. The following section briefly describes general components of the data reading system 10 and provides an example operation of the data reading system 10 as used in a retail establishment to process a transaction. With reference to FIG. 1, the data reading system 10 is used to scan, weigh (as needed), and pay for items 20 as part of a customer transaction. In some embodiments, the data reading system 10 may be designed as a self-checkout system for processing transactions without the need for assistance by store clerk or other personnel. In other embodiments, the data reading system 10 may instead be incorporated into a checkout counter operated by a clerk. For discussion purposes, it should be understood that while the drawings and relevant discussion may reference the data reading system 10 as a self-checkout system, embodiments of the disclosure also include systems that may be operated by a store clerk in an assisted checkout lane environment. Thus, it should be understood that references to “customer” are also applicable to a “clerk” or “operator” who may be the user of the data reading system 10 in certain situations. In addition, the scope of the disclosure incorporates other configurations for data reading systems that may incorporate a scale.

As illustrated in FIG. 1, the data reading system 10 is operable to obtain information (e.g., optical codes, images, etc.) from an example six-sided item 20 (e.g., a grocery item) that is passed along a direction of motion 22 through a read region of the data reading system 10. For general purposes of discussion, the item 20 is represented in the figures as a six-sided, box-shaped package having a top surface 26, a bottom surface 28, a leading side 30, a trailing side 32, a customer side 34, and a bonnet side 36. While the item 20 is illustrated and described as a box-shaped package for convenience, it should be understood that the item 20 may encompass other shapes, including, for example, round fruits or vegetables, cylindrical cans, irregularly shaped packages, such as a bag of potatoes, potato chips, or the like.

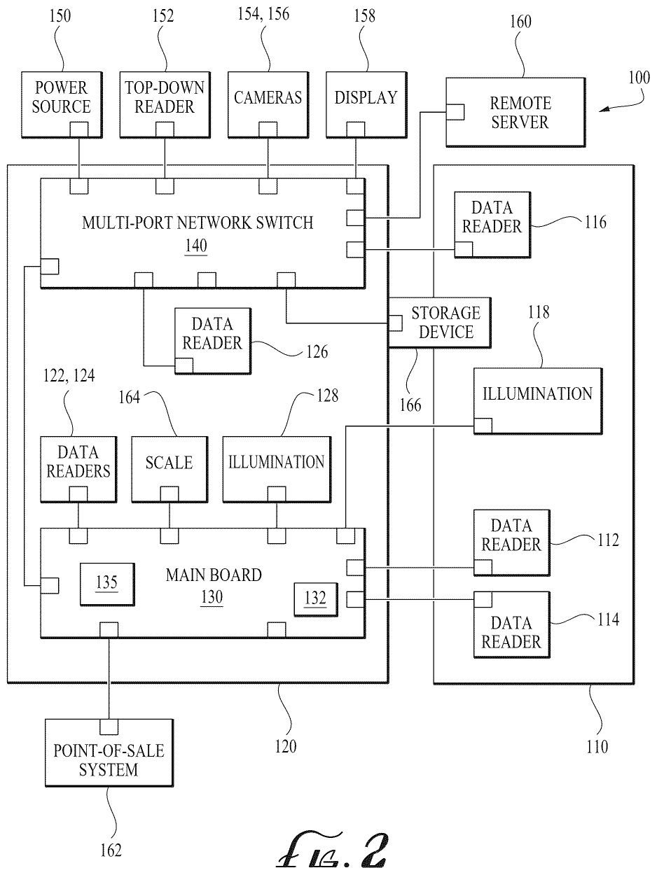

The data reading system 10 may be a two-plane or bioptic reader having a housing that includes a lower base section 40 supporting a platter 42, and a bonnet or raised upper section 44 extending from and protruding upwardly from the platter 42 (and the lower base section 40). The data reading system 10 may include a scale 164 (see FIG. 2) disposed underneath the platter 42 and within the lower base section 40, where the scale 164 may include load cells or receptors operable to weigh the item 20 (such as for items sold by weight) when the item 20 rests against the top surface of the platter 42. In some embodiments, the scale 164 may be incorporated into or otherwise operable in conjunction with the platter 42.

In some embodiments, the data reading system 10 includes one or more data readers 50 housed within lower base section 40 underneath the platter 42, and the bonnet 44 may further include one or more data readers 52 housed therein. The data readers 50, 52 are arranged within the platter 42 and bonnet 44, respectively, to project their fields-of-view through the respective scan windows 46, 48 to capture image or other suitable data for decoding an optical code on the item 20 as it moves through the combined read region of the data readers 50, 52 of the data reading system 10. In some embodiments, the data reading system 10 may incorporate mirrors or any other suitable optical components (not shown in FIG. 1) within the lower base section 40 and bonnet 44 to ensure the respective fields-of-view of the data readers 50, 52 are directed through the scan windows 46, 48 as needed to capture data from the item 20. In other embodiments, the data reading system 10 may be a single plane reader without a bonnet or may have other suitable configurations, including having a top-down data reader 54 (or 152 as shown in FIG. 2) that includes a stand extending upwardly from the lower base section 40 and above the bonnet 44. The top-down data reader 54 includes a head with one or more data readers (not shown) therein arranged to project a field-of-view from an elevated position downwardly onto the platter 42.

As illustrated in FIG. 1, in one embodiment, the top-down data reader (TDR) 54 includes a post section 56 extending upwardly from the housing 40 to any suitable height such that the TDR 54 extends above the bonnet 44 and provides an overhead view of the read region and the platter 42 to complement the view of the internal data readers 50, 52. Like the data readers 50, 52, TDR 54 is operable to capture image data for an item 20 as it moves through the read region and the platter 42 of the data reading system 10.

For purposes of this disclosure, reference to a “data reader” is used in an expansive sense to describe any suitable device (or combination of devices) capable of obtaining image data and/or other suitable data from an item 20 in a field-of-view of the device. The captured image data may thereafter be used for decoding coded information from the item 20 and/or for accomplishing any other suitable purpose related to the data reading system 10. In some embodiments, a data reader may include a camera, imager, or other suitable imaging system, a processor, a decoding unit, and a controller for communicating data to other data readers or external systems for processing. In other embodiments, the data reader may include a subset of these components within a common housing and other components may be external to the data reader itself. For example, in one embodiment, the data readers may each include an imager designed to obtain images of the item 20 and to communicate those images to the decoding unit (which may be part of the processor) in an external database for decoding the coded information captured in the images and identify the item 20. Likewise, reference to a “color data reader” or “color imager” may include a similar imager-based or other suitable system as described above operable to capture and/or process color image data from objects within its field-of-view.

“Image data” as used herein may include raw images as well as processed images (e.g., cropped, compressed, etc.) from the raw images as well as other forms of data derived from raw image data that provides useful information for image analysis, such as descriptor data, histogram data, etc. Image data may include both individual image frames as well as multiple frames (e.g., streaming video). In some embodiments, raw images may include information arranged in two dimensions which are the x (width) and y (height) coordinates of a 2D sensor. The information at each x, y coordinate may include monochrome data, RGB data, depth data, multi-spectral data, infrared data, etc. as well as combinations thereof (e.g., RGB-depth may be captured by 3D cameras). Image data may be captured by one or more imagers arranged at various positions within the housing of the data reading system, such as in a horizontal base unit or a vertical bonnet of a bioptic data reader having imagers positioned in two different planes. Single plane scanners (e.g., horizontal or vertical only housings) are also contemplated and are within the scope of the disclosure. Image data may also be captured by one or more imagers positioned external to the primary scanning unit, such as peripheral devices (e.g., top-down reader imagers, security imagers, bottom of basket readers, etc.) that may also provide image data to the fixed retail scanner and/or remote systems. In some cases, image data and images may be used interchangeably herein.

The data readers 50, 52, 54 may include any suitable decoding algorithms to decode coded information from the item 20 that may be contained within one-dimensional codes, two-dimensional codes, stacked codes, or other code configurations. In this disclosure, the data readers 50, 52, 54 may be referenced as including imagers or imaging systems, but it should be understood that the reference is meant to provide an example configuration for the data readers. Other data reading systems and data reader configurations may be used without departing from the principles of the disclosed subject matter. Examples of various configurations include those described in any of the following: U.S. Pat. No. 8,430,318, issued Apr. 30, 2013, and entitled “SYSTEM AND METHOD FOR DATA READING WITH LOW PROFILE ARRANGEMENT,” U.S. Pat. No. 9,004,359, issued Apr. 14, 2015, entitled “OPTICAL SCANNER WITH TOP DOWN READER,” U.S. Pat. No. 9,305,198, issued Apr. 5, 2016, entitled “IMAGING READER WITH IMPROVED ILLUMINATION,” U.S. Pat. No. 10,049,247, issued Aug. 14, 2018, entitled “OPTIMIZATION OF IMAGE FRAME MANAGEMENT IN A SWEEP-STYLE OPTICAL CODE DATA READER,” U.S. Pat. No. 10,248,896, issued Apr. 2, 2019, and entitled “DISTRIBUTED CAMERA MODULES SERIALLY COUPLED TO COMMON PREPROCESSING RESOURCES FACILITATING CONFIGURABLE OPTICAL CODE READER PLATFORM FOR APPLICATION-SPECIFIC SCALABILITY,” and U.S. Pat. No. 10,970,502, issued Apr. 6, 2021, and entitled “DATA COLLECTION SYSTEMS AND METHODS TO CAPTURE IMAGES OF AND DECODE INFORMATION FROM MACHINE-READABLE SYMBOLS,” and U.S. Pat. No. 12,045,686, issued Jul. 23, 2024, and entitled “FIXED RETAIL SCANNER WITH MULTI-PORT NETWORK SWITCH AND RELATED METHODS, the disclosure of each of which is incorporated by reference herein in its entirety.

With reference to FIG. 1, the following provides an example operation of the data reading system 10 in accordance with one embodiment. During a transaction, the item 20 is moved along the direction of motion 22 across the platter 42 above the horizontal scan window 46 and in front of the vertical scan window 48. As the item 20 is moved across the scan windows 46, 48, the data readers 50, 52, 54 may cooperate to obtain image data for all sides of the item 20 to find and decode the optical code. For example, if the optical code (or other target data) is present on the bonnet side surface 36 of the item 20, the data reader 52 reading through the vertical window 48 of the bonnet 44 will capture the optical code in an image of the side surface 36 for decoding. Similarly, if the optical code is on the bottom surface 28 of the item 20, then the data reader 50 reading through the horizontal window 46 may capture the optical code in an image for decoding. Likewise, TDR 54 may also capture images and/or process optical codes along a top surface 26 of the item 20. If the optical code is on any of the remaining surfaces of the item 20, one or all data readers 50, 52, 54 (either individually or in combination) may capture image views bearing the optical code on the item 20 for decoding. For items 20 sold by weight, the item 20 is positioned on the platter 42 for weighing via the scale 164.

If the optical code is positively captured and decoded or if the item weight is accurately obtained, the data reading system 10 may emit a beeping (or other) sound indicating that the item 20 has been processed, and the customer 38 may proceed to the next item 20. Alternatively, the data reading system 10 may emit a different beeping (or other) sound indicating that the item 20 was not properly processed and present a message requesting that the customer 38 reprocess the item 20. Other feedback methods may also be provided, such as visual feedback (e.g., via an LED or an electronic display), indicating a successful read or an unsuccessful read.

In some embodiments, the data reading system 10 may include a screen or other display 158 (see FIG. 2) operable to display information, such as a running transaction list of the items 20 purchased, images, selectable icons, text, or other suitable information to facilitate the transaction. In some embodiments, the display 158 may show an image of a purchased item captured by the data readers 50, 52, 54 (or other cameras internal to the data reader housing), a list of purchase items and running costs, the weight of an item and the cost per pound of the item, or other suitable transaction information associated with the items 20. In some embodiments, the display 158 may be a touch screen that allows the customer 38 to interact directly with the screen (or via a stylus or other suitable instrument) to enter information and respond to prompts to allow the customer 38 to manage the transaction. The touch screen may be any of several suitable display types, such as an integrated liquid crystal (LCD) display, an organic light-emitting diode (OLED) display, or other display with suitable touch screen capabilities for detecting the customer's touch via a finger, stylus, or other suitable input device.

FIG. 2 is a simplified block diagram of a data reading system 100 according to an example embodiment of the disclosure. As illustrated in FIG. 2, the data reading system 100 may be operably coupled with one or more of a power source 150, a top-down reader (also referred to as a “TDR”) 152, peripheral cameras 154, 156, a display 158, a remote server 160, and/or a point of sale (POS) system 162. Additional details of the data reading system 100 are described below.

With reference to FIG. 2, the data reading system 100 may be a bioptic data reader having a vertical housing 110 and a horizontal housing 120 (arranged in a similar fashion as the data reader 10 of FIG. 1) in some embodiments. The data reading system 100 may be installed in a retail environment (e.g., grocery store), which typically is disposed within a counter or other support structure of an assisted checkout lane or a self-checkout lane. The vertical housing 110 provides an enclosure for one or more data readers 112, 114, 116, active illumination assemblies 118 (e.g., LED assemblies), and other optical elements (e.g., lenses, mirrors, etc.) and electrical elements (e.g., cables, circuit boards, etc.) therein. Similarly, the horizontal housing 120 provides an enclosure for one or more data readers 122, 124, 126, active illumination elements 128 (e.g., LED assemblies), a scale 164, and other optical elements (e.g., lenses, mirrors, etc.) and electrical elements (e.g., cables, circuit boards, etc.) therein. Bioptic data readers tend to have a larger horizontal housing 120 as compared to the vertical housing 110, which provides space to support various components of the data reading system 100 and the scale 164 used to weigh produce or other items sold by weight or otherwise perform weighing of items when placed on the horizontal surface (often called a “weigh platter”).

In some embodiments, the vertical housing 110 and the horizontal housing 120 may be generally orthogonal to each other (including slightly angled orientations, such as being in the range of ±10° from orthogonal). Depending on the arrangement and orientation of the different opto-electrical elements, certain elements related to providing a horizontal field of view may be physically located within the vertical structure and vice versa.

In one embodiment, the data reading system 100 may include one or more different types of data readers, such as monochrome imagers and/or color imagers. For example, in one embodiment, data readers 112, 114 in vertical housing 110 may be monochrome imagers configured to capture monochrome images through the vertical window (e.g., window 48 of FIG. 1) of the data reading system 100. Likewise, data readers 122, 124 in horizontal housing 120 may be monochrome imagers configured to capture monochrome images through the horizontal window of the data reading system 100. Data reader 116 in vertical housing 110 may be a color camera module configured to capture color images through the vertical window of the data reading system 100. Likewise, data reader 126 in horizontal housing 120 may be a color camera module configured to capture color images through the horizontal window of the data reading system 100. Similarly, peripheral cameras 154, 156 may be either monochrome imagers and/or color imagers. In such embodiments, monochrome images may be analyzed (e.g., by a decoder) to decode one or more indicia (e.g., 1D barcodes, 2D barcodes, optical character recognition, digital watermarks, etc.), and color images may be analyzed (e.g., by an image processor) where color information may be particularly advantageous, such as produce recognition, item recognition or verification, and security analysis. Such analysis may be performed by local and/or remote processors that may contain an artificial intelligence (AI) engine or otherwise configured to perform other machine learning techniques.

The data reading system 100 may further include a main board 130 and a multi-port network switch 140. As shown herein, the main board 130 and the multi-port network switch 140 may be disposed within the horizontal housing 120 in one embodiment. It is contemplated that other embodiments may instead include the main board 130 and/or the multi-port network switch 140 within the vertical housing 110. In an embodiment where one of the multi-port network switch 140 or the main board 130 is disposed within the vertical housing 110 and the other is disposed within the horizontal housing 120, the two boards may be generally oriented orthogonal to each other similar to the orientation of the windows or another angled relationship (e.g., slightly angled orientations such as being in the range of ±10° from orthogonal). The ports may be at least somewhat aligned in the orthogonal direction or other arrangement to accommodate easy connection of network cables therebetween.

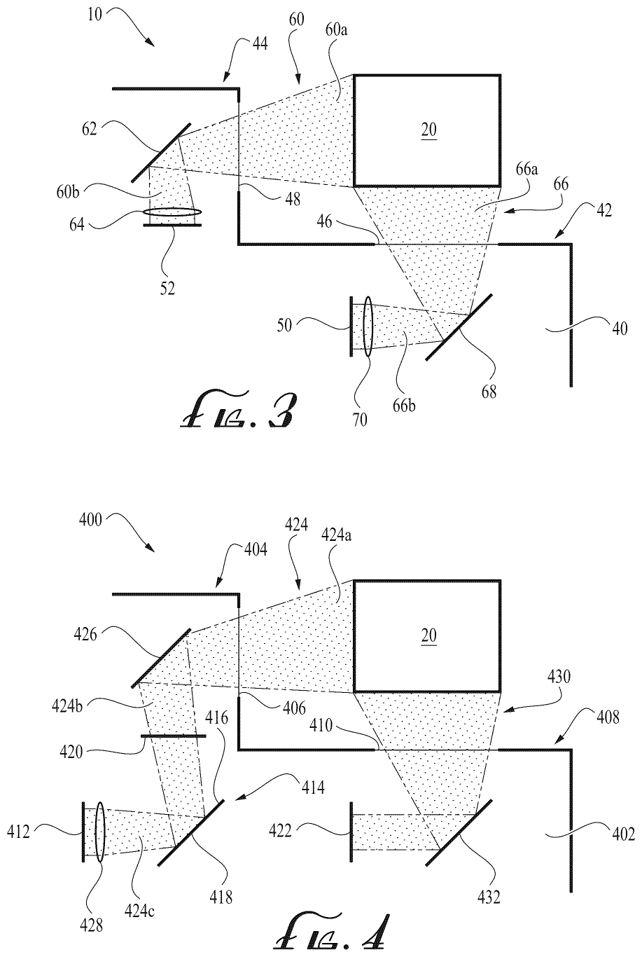

The main board 130 may be operably coupled with the data readers 112, 114 and the data readers 122, 124, such as via a communication interface (e.g., a MIPI interface) or other suitable interface. The main board 130 may have decoding software embedded therein and/or stored within internal memory 132 such that one or more on-board processors 135 may receive monochrome images to perform decoding on the optical indicia and provide the decoding result to a point of sale (POS) system 162 operably coupled thereto to complete a transaction. The one or more on-board processors 135 may also be configured to provide control (e.g., coordination or synchronization) of the various components of the system including camera exposure and timing of active illumination assemblies 118, 128 of the system. In addition, the one or more on-board processors 135 may also manage a boot sequence for initializing the data reading system 100 and for powering and configuring the various components of the data reading system 100 as further discussed with particular reference to FIG. 3. Suitable software and/or executable instructions for managing the boot sequence and other aspects of the data reading system 100 may be stored within internal memory 132 or another suitable location in communication with the processors 135.

Although a single block is shown representing one or more on-board processors 135, it is contemplated that some embodiments may include multiple processing components (e.g., microprocessors, microcontrollers, FPGAs, AI accelerator modules, etc.) configured with suitable instructions and programming to perform different tasks, alone or in combination, including object detection, system control, diagnostic and performance monitoring, optical code decoding, optical character recognition, artificial intelligence, machine learning analysis, and/or image processing techniques to support the functionality of the data reading system 100.

In one embodiment, the multi-port network switch 140 may be operably coupled to data reader 116, data reader 126, and with main board 130 located within the data reading system 100. Multi-port network switch 140 may also be operably coupled to the power source 150 as well as peripheral devices such as TDR 152, peripheral cameras 154, 156, display 158, the remote server 160, and/or a removable storage device 166. The number and types of peripheral devices may depend on a desired application within a retail environment. The TDR 152 may be configured as a stand connected to the data reading system 100 that typically provides a generally close overhead (angled) view of the read-zone to provide a top view of a product (as illustrated in FIG. 1) whereas internal data readers 112, 114, 116, 122, 124, 126 may be better suited for capturing images of the bottom and/or sides of the object within the read-zone. Additional TDRs are also contemplated as being connected to the data reading system 100. In some embodiments, peripheral cameras 154, 156 may be located remotely from the housing of the data reading system 100 such as being mounted on a ceiling or wall of the retail environment to provide additional views of the read-zone or checkout area. Such views may be useful for security analysis of the checkout area such as product verification, object flow, and human movements with the retail establishment. Such analysis may be performed by a remote service or other local devices (e.g., located on or otherwise coupled to the main board 130 or ethernet switch 140). Other peripheral devices may be located near the data reading system 100, such as a peripheral presentation scanner resting or mounted to a nearby surface, and/or a handheld scanner that also may be used for manual capturing by the user (e.g., checkout assistant or self-checkout customer). Such devices may be coupled directly to the main board 130 in some embodiments or to the multi-port network switch 140 if so enabled. As shown, the POS 162 may be coupled directly to the main board 130. Such a connection may be via communication interfaces such as USB, RS-232, or other such interfaces. In some embodiments, the POS 162 may be coupled directly to the multi-port network switch 140 if so enabled (e.g., as an Ethernet connected device).

The multi-port network switch 140 may be implemented on a separate board from the main board 130. In some embodiments, the multi-port network switch 140 may be implemented on the main board 130 that also supports the one or more processors 135. The multi-port network switch 140 may include a plurality of ports to provide advanced network connectivity (e.g., Ethernet) between internal devices (e.g., CCMs 116, 126) within the data reading system 100 and external devices (e.g., TDR 152, peripheral camera(s) 154, 156, display 158, remote server 160, etc.) disposed outside the vertical and horizontal housings 110, 120 of the data reading system 100. Thus, the multi-port network switch 140 may provide an Ethernet backbone for the elements within the data reading system 100 as well as for external devices coupled to the data reading system 100 for control and/or managing data flow or analysis. As an example, multi-port network switch 140 may be implemented with a KSZ9567 Ethernet switch or other EtherSynch® product family member available from Microchip Technology Inc of Chandler, Arizona or other similar products or devices configured to provide network synchronization and communication with network-enabled devices. Embodiments of the disclosure may include any number of ports supported by the multi-port network switch to couple to both internal devices (e.g., main board, cameras, etc.) and external devices (e.g., peripheral cameras, TDR, illumination sources, remote servers, etc.) to provide a flexible platform to add additional features for connecting with the data reading system 100.

Although FIG. 2 shows one block for active illumination assemblies 118, 128 in each of the vertical and horizontal housings 110, 120, some embodiments may include multiple such assemblies in each of the horizontal and vertical housings 110, 120 to provide for different lighting options at different angles across the read-zone. For example, the vertical housing 110 may include two (or more) illumination assemblies therein at different locations and/or different colors for a desired illumination field from the vertical view. Likewise, the horizontal housing 120 may include two (or more) illumination assemblies therein at different locations and/or different colors for a desired illumination field from the horizontal view. As shown herein, the illumination assemblies 118, 128 may be coupled directly to the main board 130. However, in some embodiments, additional components may be coupled within the path from the main board 130 such as a control panel or other such device. In yet other embodiments, the illumination assemblies 118, 128 may be coupled to the multi-port network switch 140 which may route triggering controls from the main board 130. TDR 152, one or more of the peripheral cameras 154, 156, and the display 158 may also include associated illumination assemblies to supporting functionality of the respective components. Synchronization of such illumination sources may be managed by the multi-port network switch 140 as controlled by the main board 130. In some embodiments, the multi-port network switch may employ or leverage IEEE1588 Precision Time Protocol to synchronize the illumination system with remote cameras, which may enable clock accuracy in sub-microsecond range.

In operation, images may be captured by any one or more of the data readers 112, 114, 116, 122, 124, 126 (including TDR 152 and peripherals cameras 154, 156). Monochrome images may be captured by monochrome data readers 112, 114, 122, 124 and color images may be captured by color data readers 116, 126. Similarly, monochrome and/or color images may be captured by the TDR 152 and/or peripherals cameras 154, 156 depending on their configuration. The multi-port network switch 140 may be configured to coordinate (e.g., synchronize) timing of camera exposure and active illumination (e.g., white illumination) with the color data readers 116, 126 (as controlled by the controller on the main board 130) to occur in an offset manner with the timing of the camera exposure and active illumination (e.g., red illumination) with the monochrome data readers 112, 114, 122, 124.

Image data (e.g., streaming video, image frames, etc.) from the color data readers 116, 126 may be routed through the multi-port network switch 140 to the processing/analysis modules located internal to the data reading system 100 such as the one or more processors 135 supported by the main board 130. As such, image analysis (e.g., AI, machine learning, OCR, object recognition, item validation, produce recognition, analytics, etc.) may be performed on the color images internally within the data reading system 100 by the one or more processors 135 supported by the main board 130. In some embodiments, barcode decoding may also be performed on the captured color images internally within the data reading system 100 by the one or more processors 135 supported by the main board 130. Image data from the color data readers 116, 126 may also be routed through the multi-port network switch 140 to external devices, such as remote server 160 or other similar devices including any network enabled POS systems. As such, image analysis (e.g., AI, machine learning, OCR, object recognition, item validation, produce recognition, analytics, etc.) may be performed on the color images externally to the data reading system 100 by external devices coupled through the multi-port network switch 140. Such color images or other data stream may be routed directly to the network connected external devices through the multi-port network switch 140 without first being received by the main board 130 (if at all). In other words, image data may be communicated (e.g., passed) from at least one imager internal to the data reader through the at least one multi-port network device 140 and on to at least one external device bypassing the main board 130. Having a connection to both the main board 130 as well as to external devices via the multi-port network switch enables image data to be provided to internal as well as external processing resources. In some embodiments, data readers 116, 126 may have their own on-board processors configured to perform image analysis, decoding, and/or other pre-processing of the image data separate from, or in coordination with, processing done on the main board 130 or other remote systems.

Image data from the monochrome data readers 112, 114, 122, 124 may be provided to the main board 130 to the processing/analysis modules located internal to the data reading system 100 such as the one or more processors 135 supported by the main board 130. As such, barcode decoding may also be performed on the color images internally within the data reading system 100 by the one or more processors 135 supported by the main board 130. In some embodiments, image analysis (e.g., AI, machine learning, OCR, object recognition, item validation, produce recognition, analytics, etc.) may be performed on the monochrome images internally within the data reading system 100 by the one or more processors 135 supported by the main board 130. Image data from the monochrome data readers 112, 114, 122, 124 may also be routed through the multi-port network switch 140 to external devices, such as remote server 160 or other similar devices including any network enabled POS systems. As such, image analysis (e.g., AI, machine learning, OCR, object recognition, item validation, produce recognition, analytics, etc.) may be performed on the monochrome images externally to the data reading system 100 by external devices coupled through the multi-port network switch 140. Such monochrome images or other data stream may be routed directly to the network connected external devices to the multi-port network switch 140 after first being received by the main board 130.

Image data (e.g., streaming video, image frames, etc.) from the TDR 152 or other external peripheral cameras 154, 156 may also be routed through the multi-port network switch 140 to the processing/analysis modules located internal to the data reading system 100 such as the one or more processors 135 supported by the main board 130. As such, image analysis (e.g., AI, machine learning, OCR, object recognition, item validation, produce recognition, analytics, etc.) may be performed on the images (e.g., color and/or monochrome) internally within the data reading system 100 by the one or more processors 135 supported by the main board 130. In some embodiments, barcode decoding may also be performed on such images captured by the TDR 152 and other external peripheral cameras 154, 156 internally within the data reading system 100 by the one or more processors 135 supported by the main board 130. Image data from the TDR 152 or other external peripheral cameras 154, 156 may also be routed through the multi-port network switch 140 to external devices, such as the display 158, the remote server 160, point-of-sale system 162, or other similar devices including any network enabled POS systems. As such, image analysis (e.g., AI, machine learning, OCR, object recognition, item validation, produce recognition, analytics, etc.) may be performed on these images externally to the data reading system 100 by external devices coupled through the multi-port network switch 140. Such images or other data stream may be routed directly to the network connected external devices through the multi-port network switch 140 without first being received by the main board 130 (if at all).

The multi-port network switch 140 may be coupled to the main board 130 via a single cable configured to provide power and communication to the main board 130. Power may be provided to the system via power source 150 via the multi-port network switch 140, which in turn provides power (e.g., power over Ethernet (PoE)) to the main board 130 and the data readers 116, 126. Data readers 112, 114, 122, 124 and illumination assemblies 118, 128 may be powered via the main board 130.

Features of employing the multi-port network switch 140 as a primary backbone for communication and power to interface between both internal and external components of the system include enabling power, communications, and camera/illumination synchronization to occur over a single cable between such connected components. In addition, precision time protocol (PTP), generic precision time protocol (GPTP), time sensitive networking (TSN) may provide an improved synchronization (e.g., within 1 microsecond error) for an open standard, widely supported, single cable solution. In addition, scanner maintenance tools may be simplified via improved network connectivity.

FIG. 3 is a schematic illustration of the conventional data reading system 10 of FIG. 1 with a dual-imager configuration for obtaining two sets of image data from an item in accordance with one embodiment. With reference to FIG. 3, the data reading system 10 is a bioptic scanner with a vertical housing 42 and a horizontal housing 44 as described previously. With reference to FIG. 3, the data reading system 10 includes a data reader 52 (which may be a monochrome or color imager) having a field-of-view 60 directed outwardly through the vertical scan window 48 of the vertical housing 42, where the field-of-view 60 is directed in a generally horizontal direction toward the item 20 to capture image data for further processing to identify and decode a detected optical code (or other target data). The field-of-view 60 may include a first view segment 60a that passes through the vertical scan window 48 and is then redirected downwardly by a mirror 62 (or other suitable optical element), whereby a second view segment 60b is focused by a lens system 64 onto the data reader 52. In a similar fashion, the data reading system 10 includes a data reader 50 (which may be a monochrome or color imager) having a field-of-view 66 directed outwardly through the horizontal scan window 46 of the horizontal housing 44, where the field-of-view 66 is directed in a generally vertical direction toward the item 20 to capture image data for further processing to identify and decode a detected optical code (or other target data). The field-of-view 66 may include a first view segment 66a that passes through the horizontal scan window 46 and is then redirected horizontally by a mirror 68 (or other suitable optical element), whereby a second view segment 66b is focused by a lens system 70 onto the data reader 50. In some embodiments, the separate data readers 50, 52 may be mounted onto a common printed circuit board (not shown) or may each be standalone data readers with separate components. Regardless of the particular imager configuration, the conventional data reading system 10 simultaneously captures one or more images from each of the respective fields-of-view 60, 66 and processes the respective images separately from one another to decode an optical code associated with the item 20.

As noted previously, arrangements for data reading systems requiring multiple imagers for processing items such as those illustrated in FIGS. 1-3 tend to be costly and increase manufacturing delays due to the additional components and related installation issues. As further described in detail below, FIGS. 4-9 illustrate various embodiments for data reading systems with a streamlined arrangement using a single data reader to obtain image data of an item 20 through one or more scan windows. Additional details of these and other embodiments are provided with more detail below with particular reference to the figures.

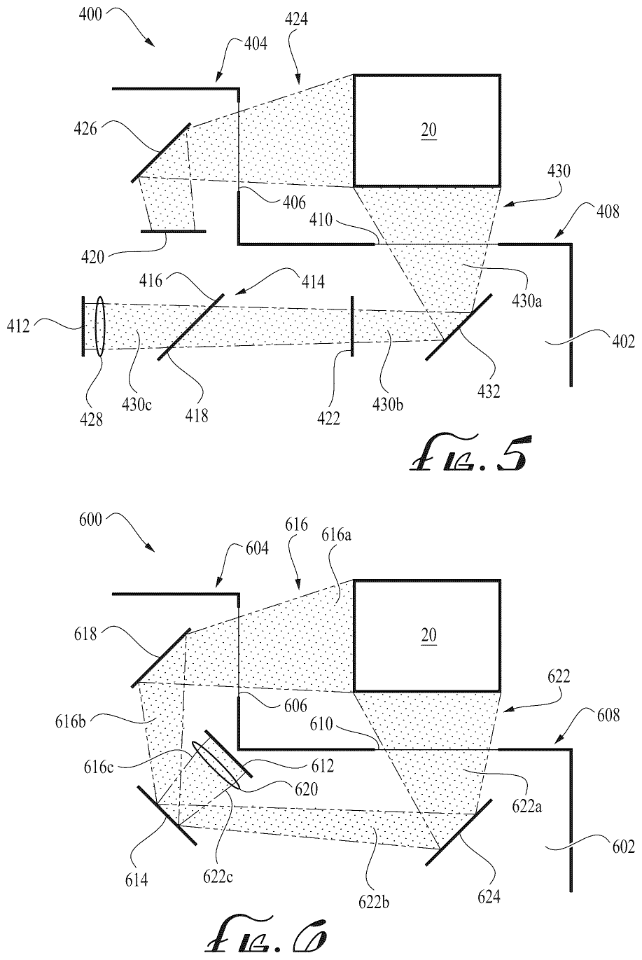

FIGS. 4-5 collectively illustrates a dual-plane data reading system 400 with a single-reader configuration for obtaining image data from an item through first and second scan windows in accordance with one embodiment. For ease of understanding, the data reading system 400 is illustrated schematically in FIGS. 4-5 and focuses on particular features and components to avoid obscuring the pertinent aspects of the disclosure. It should be understood that the data reading system 400 may incorporate many of the components and features of the data reading systems 10, 100 described with reference to FIGS. 1-2 that may not otherwise be illustrated in FIG. 4 for simplicity. In other words, it should be understood that the disclosure contemplates combining the features of the data reading system 400 described with reference to FIG. 4 with suitable supporting features of the data reading systems 10, 100.

With reference to FIG. 4, the data reading system 400 is a bioptic scanner with a housing 402 including a vertical housing 404 with a vertical scan window 406 and a horizontal housing 408 with a horizontal scan window 410 arranged in a similar fashion as described previously with reference to FIGS. 1-3. The data reading system 400 includes a single data reader 412 (e.g., a monochrome imager, a color imager, or other suitable imaging system) within the housing 402 and further includes various optical components arranged to direct light to the data reader 412 from at least one field-of-view 424 extending through the vertical scan window 406 and at least one field-of-view 430 extending through the horizontal scan window 410.

For example, in one embodiment, the optical components of the data reading system 400 may include a one-way mirror 414 having a reflective surface 416 that reflects received light and an opposite transmissive surface 418 that allows light to pass through the one-way mirror 414. The data reading system 400 may further include spatial light modulators, such as transmissive light valves 420, 422, that are configurable to control a light transmission pathway (e.g., control a level of illumination passing therethrough) and allow the data reader 412 to capture image data from one of multiple fields-of-view at a time. In the embodiment of FIGS. 4-5, control of the light valves 420, 422 may be accomplished by altering application of a voltage to set the respective light valves in a reflective or transmissive state.

FIG. 4 illustrates an example configuration for capturing image data from the item 20 via the vertical scan window 406 of the data reading system 400. With reference to FIG. 4, a first field-of-view 424 is directed outwardly through the vertical scan window 406 of the vertical housing 404, where the first field-of-view 424 is directed in a generally horizontal direction toward the item 20 to allow the data reader 412 to capture image data for further processing to identify and decode a detected optical code (or other target data). The first field-of-view 424 may include a first view segment 424a that passes through the vertical scan window 406 and is then redirected downwardly by a first mirror 426 (or other suitable optical element operable for reflecting light), whereby a second view segment 424b is directed toward a first light valve 420 that generally faces the first mirror 426. As illustrated in FIG. 4, the first light valve 420 is configured to allow light to pass through (whereas second light valve 422 is configured to substantially block and/or deflect light transmission in the path of the horizontal housing 408 to keep the light away from an optical path associated with the data reader 412). As such, the second view segment 424b of the first field-of-view 424 passes through the first light valve 420 and is redirected by the reflective surface 416 of the one-way mirror 414 that generally faces the first light valve 420, whereby a third view segment 424c of the first-field-of view 424 is focused by a lens system 428 onto the single data reader 412. In this fashion, the image data from the item 20 is captured by the data reader 412 through the vertical scan window 406 and is processed to detect a presence of optical codes (or other target data) for subsequent decoding. As noted previously, in FIG. 4, during this time the second light valve 422 is configured to substantially block and/or deflect light transmission, thereby effectively blocking the data reader 412 from capturing data via a second field-of-view 430 through the horizontal scan window 410.

FIG. 5 illustrates an example configuration for capturing image data from the item 20 via the horizontal scan window 410 of the data reading system 400. With reference to FIG. 5, the second field-of-view 430 is directed outwardly through the horizontal scan window 410 of the horizontal housing 408, where the second field-of-view 430 is directed in a generally vertical direction toward the item 20 to capture image data for further processing to identify and decode a detected optical code (or other target data). The second field-of-view 430 may include a first view segment 430a that passes through the horizontal scan window 410 and is then redirected horizontally by a second mirror 432 (or other suitable optical element operable for reflecting light), whereby a second view segment 430b is directed toward the second light valve 422. In this configuration, the second light valve 422 is configured to allow light to pass through (whereas the first light valve 420 now blocks and/or deflects light transmission away from the data reader 412). As such, the second view segment 430b of the second field-of view 430 passes through the second light valve 422 and toward the transmissive surface 418 of the one-way mirror 414 facing the second light valve 422. The second view segment 430b of the second field-of view 430 passes through the transmissive surface 418 of the one-way mirror 414 and is focused by the lens system 428 onto the single data reader 412. In this fashion, the image data from the item 20 is captured by the data reader 412 through the horizontal scan window 410 and is processed to detect a presence of optical codes (or other target data) for subsequent decoding. As noted previously, in FIG. 5, during this time the first light valve 420 is configured to block and/or deflect light transmission, thereby effectively blocking the data reader 412 from capturing data via the first field-of-view 424 through the vertical scan window 406.

In some embodiments, the data reading system 400 may control the fields-of-view 424, 430 through which the data reader 412 captures image data by alternating a voltage applied to the light valves 420, 422 in a cyclical manner. In this fashion, the data reader 412 may capture image data of the item 20 and cycle between field-of-view 424 through the vertical scan window 406 and field-of-view 430 through the horizontal scan window 410 in a repeating pattern. In some embodiments, the voltage application to the light valves 420, 422 may be preprogrammed and/or controlled via the main board 130 (such as via the processor 135), the remote server 160, and/or any other suitable components of the data reading system 400 (see FIG. 2). In some embodiments, the data reading system 400 may include one or more illumination assemblies (e.g., illumination assemblies 118, 128 of FIG. 2) to provide sufficient illumination for aiding the image capture process. The illumination sources may include polarization filters to control brightness as desired. In some embodiments, the illumination assemblies may be pulsed at a rate that substantially matches (or is a multiple thereof) the voltage control profile of the light valves 420, 422 to synchronize illumination during the image capture process.

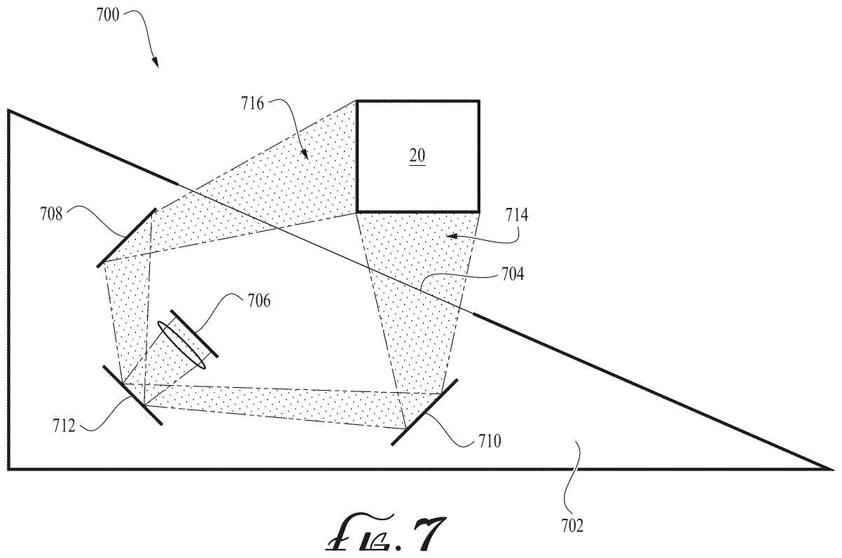

The embodiment illustrated in FIGS. 4-5 describes the use of spatial light modulators, in particular light valves 420, 422, to cycle between multiple fields-of-view of the data reading system 400. In other embodiments, the light valves 420, 422 may be replaced with other suitable devices operable for controlling light transmission. In still other embodiments, a different type of spatial light modulator may be used, such as a digital micromirror device. Examples embodiments using a digital micromirror device are described below with reference to FIGS. 6-7.

FIG. 6 illustrates a dual-plane data reading system 600 with a single-reader configuration for obtaining image data from an item, the system 600 including a digital micromirror device 614 operable to alternate the reader's field-of-view through multiple scan windows in a similar fashion as described previously with reference to FIGS. 4-5. For ease of understanding, the data reading system 600 is illustrated schematically in FIG. 6 and focuses on particular features and components to avoid obscuring the pertinent aspects of the disclosure. It should be understood that the data reading system 600 may incorporate many of the components and features of the data reading systems 10, 100 described with reference to FIGS. 1-2 that are not otherwise illustrated in FIG. 6 for simplicity. In other words, the disclosure contemplates combining the features of the data reading system 600 described with reference to FIG. 6 with suitable supporting features of the data reading systems 10, 100.

With reference to FIG. 6, the data reading system 600 is a bioptic scanner with a housing 602 including a vertical housing 604 with a vertical scan window 606 and a horizontal housing 608 with a horizontal scan window 610 arranged in a similar fashion as described previously with reference to FIGS. 1-3. The data reading system 600 includes a single data reader 612 (e.g., a monochrome imager, a color imager, or other suitable imaging system) within the housing 602 and further includes various optical components arranged to direct light to the data reader 612 from at least one field-of-view extending through the vertical scan window 606 and at least one field-of-view extending through the horizontal scan window 610.

For example, in one embodiment, the optical components may include a digital micromirror device 614 configured to selectively redirect light received through the scan windows 606, 610 and thereby alternate the fields-of-view of the data reader 612 through which image data of the item 20 may be captured. Briefly, the digital micromirror device 614 is a device that includes a plurality of microscopic mirrors arranged in an array, where the mirrors can be individually controlled and rotated within a rotational range (e.g., ±10 degrees) to either reflect received light to a desired target region or to reflect light away from the target region. In other words, the digital micromirror device 614 may be operated to direct one field-of-view to the data reader 612 while directing the other field-of-view away from the data reader 612, and vice versa, to effectively alternate between the fields-of-view and accommodate image data capture through multiple fields-of-view as further described in detail below.

FIG. 6 illustrates an example embodiment for capturing image data from the item 20 via alternating fields-of-view directed through the scan windows 606, 610. With reference to FIG. 6, a first field-of-view 616 is directed outwardly through the vertical scan window 606 of the vertical housing 604, where the first field-of-view 616 is directed in a generally horizontal direction toward the item 20 to capture image data for further processing to identify and decode a detected optical code (or other target data). The first field-of-view 616 may include a first view segment 616a that passes through the vertical scan window 606 and is then redirected downwardly by a first mirror 618 (or other suitable optical element operable for reflecting light), whereby a second view segment 616b of the first field-of-view 616 is directed toward the digital micromirror device 614 facing the first mirror 618, whereby a third view segment 616c of the first field-of-view 616 may be focused by a lens system 620 onto the single data reader 612. In a similar fashion, the data reading system 600 includes a second field-of-view 622 directed outwardly through the horizontal scan window 610 and in a generally vertical direction toward the item 20 to capture image data for further processing to identify and decode a detected optical code (or other target data). The second field-of-view 622 may include a first view segment 622a that passes through the horizontal scan window 610 and is then redirected horizontally by a second mirror 624 (or other suitable optical element), whereby a second view segment 622b is directed toward the digital micromirror device 614 facing the second mirror 624, whereby a third view segment 622c may be focused by the lens system 620 onto the single data reader 612.

The plurality of micromirrors of the digital micromirror device 614 may be selectively actuated to control which field-of-view 616, 622 is available for the single data reader 612 to capture the image data. For example, some micromirrors (not shown) of the digital micromirror device 614 may be positioned to direct light from the first field-of-view 616 to the single data reader 612, while other micromirrors (not shown) may be positioned to direct light from the second field-of-view 624 away from the data reader 612 during a first time. In this fashion, the image data of the item 20 is captured by the data reader 612 via the first field-of-view 616 through the vertical scan window 606 and is processed to detect and decode any captured optical codes, while no image data is captured via the second field-of-view 622. Thereafter, during a second time the array of micromirrors may be repositioned to instead direct light from the second field-of-view 622 toward the data reader 612 and the light from the first field-of-view 616 away from the data reader 612 to capture image data through the horizontal scan window 610, while no image data is captured via the first field-of-view 616. In some embodiments, the positioning of the micromirrors of the digital micromirror device 614 may be alternated cyclically to toggle between the fields-of-view 616, 624 through which the data reader 612 captures the image data. The positioning of the micromirrors may be preprogrammed and/or controlled via the main board 130 (including the processor 135), the remote server 160, and/or other suitable components of the data reading system 600 (see FIG. 2).

FIG. 7 illustrates a single-plane data reading system 700 with a single-imager configuration for obtaining image data from an item (not shown) at different angles through a single scan window in accordance with one embodiment. In some embodiments, the fields-of-view 712, 714 may at least partially overlap one another across a central region over the scan window 704 to help ensure the collective field-of-view is sufficiently large for successful reads and/or may view different sides of the item as it passes through the scan region.

As illustrated in FIG. 7, the data reading system 700 includes a housing 702 with a single scan window 704 and includes an optical arrangement similar to that of the data reading system 600 of FIG. 6 but optimized to provide multiple fields-of-view for a single data reader 706 at different angles through the same scan window 704. Briefly, the data reading system 700 includes a pair of mirrors 708, 710 and a digital micromirror device 712 arranged to direct a first field-of-view 714 or a second field-of-view 716 through the same scan window 704 at different times depending on the positioning of the micromirror device 712 to allow the single data reader 716 to capture image data from an item (not shown) passing through the fields-of-view 712, 714. In a similar fashion as described with reference to the data reading system 600 of FIG. 6, it should be understood that although both field-of-view 712, 714 are shown in FIG. 7 as being directed toward the data reader 706, the digital micromirror device 710 may be controlled to position the mirror arrays as needed to alternately toggle between the fields-of-view 712, 714 for the data reader 706 in terms of which field-of-view 712, 714 is directed toward the data reader 706 and which field-of-view 712, 714 is directed away from the data reader 706 at a given time.

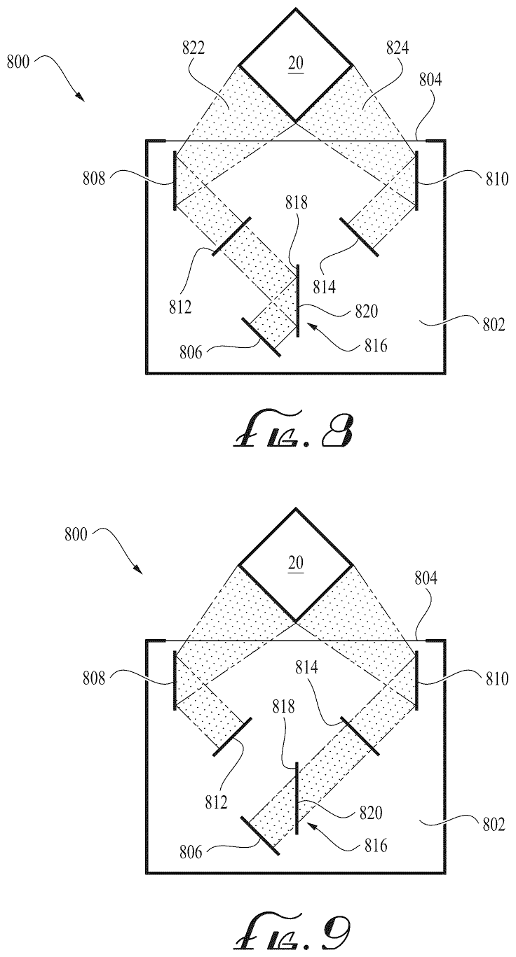

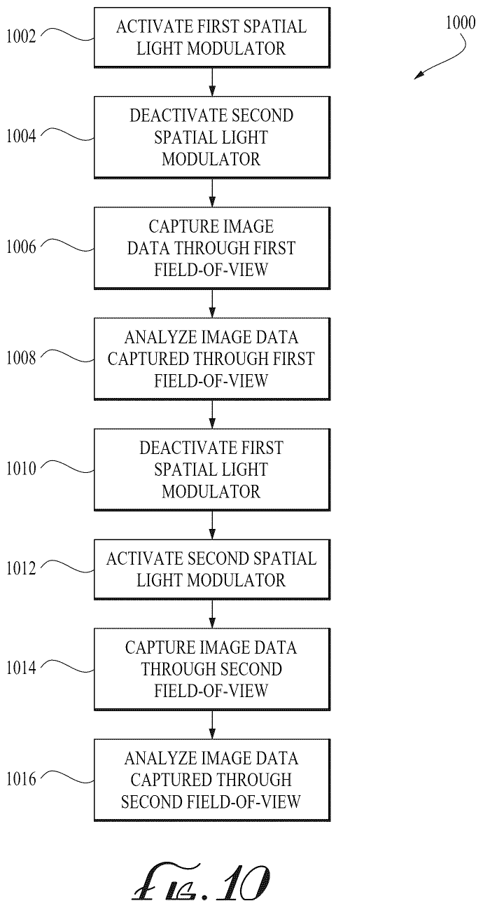

FIGS. 8 and 9 collectively illustrate a single-plane data reading system 800 with a single-imager configuration for obtaining image data from an item through one scan window in accordance with one embodiment. As illustrated in FIGS. 8 and 9, the data reading system 800 includes a housing 802 with a single scan window 804 and includes an optical arrangement similar to that of the data reading system 400 of FIG. 4 but optimized to provide multiple fields-of-view for a single data reader 806 at different angles through the same scan window 804. Briefly, the data reading system 800 includes a pair of mirrors 808, 810, a pair of light valves 812, 814 and a one-way mirror 816 having a first reflective surface 818 and an opposite transmissive surface 820. In a similar fashion as described with reference to the data reading system 400 of FIG. 4, during a time when the first light valve 812 is active and the second light valve 814 is inactive, a first field-of-view 822 is directed from the first mirror 808 through the light valve 812 and reflected from the reflective surface 818 of the one-way mirror 816 toward the data reader 806. Since second light valve 814 is inactive, a second field-of-view 824 is blocked in a similar fashion as described previously with reference to data reading system 400. With reference to FIG. 9, during another time when the second light valve 814 is active and the first light valve 812 is inactive, the second field-of-view 824 is directed from the second mirror 810 through the second light valve 814 and passes through the transmissive surface 820 of the one-way mirror 816 toward the data reader 806. In this fashion, the image data from the item 20 is captured by the data reader 806 through at least one of the fields-of-view 822, 824 directed outwardly through the single scan window 804 and processed to detect and decode any captured optical codes present in the image data. In some embodiments, the fields-of-view 822, 824 may at least partially overlap one another at different angles across a central region over the scan window 804 to help ensure the collective field-of-view is sufficiently large for successful reads or for viewing different sides of the same item.

It should be understood that various aspects of the embodiments of FIGS. 3-9 may be combined without departing from the principles of the disclosed subject matter. For example, in some embodiments, the configuration of the data reading system 800 of FIGS. 8, 9 may be implemented in one or both of the housings of a bioptic data reader (such as the data reading system 400 of FIG. 4) to accommodate multiple fields-of-view through one or both of the vertical scan window and the horizontal scan window and provide a single data reader with additional views from which to capture image data of the item for processing. In some embodiments, additional light valves and mirrors may be added to the data reading system in a corresponding configuration as described with reference to the disclosed embodiments to increase the number of fields-of-view through a scan window for the data reader while reducing the number of data readers used in conventional systems or the need for providing different segments of the data reader for different views. As such, the full area of a single reader may be used for multiple fields-of-view.

As described in further detail below with particular reference to method 1000 of FIG. 10, the disclosed data reading systems 400, 600, 700, 800 each include a streamlined design for capturing image data of an item using a single data reader having multiple fields-of-view in either a single-plane or dual-plane configuration. The following description provides additional details of the data reading method 1000 that may be used in conjunction with any of the data reading systems 400, 600, 700, 800 in accordance with one embodiment.

With reference to FIG. 10, at step 1002, the processor 135, and/or other suitable component(s) of the data reading systems 400, 600, 700, 800 that may be in communication with the processor 135, activates and configures a first spatial light modulator (e.g., a light valve or other suitable optical device operable to reflect or transmit light) to allow light to pass therethrough. At step 1004, the processor 135 deactivates a second spatial light modulator so that it blocks light transmission therethrough.

At step 1006, the single data reader captures image data of a read region through a first field-of-view of the data reading system, wherein the first field-of-view includes light passing through the first spatial light modulator. In some embodiments, the processor 135 may also activate any associated illumination sources (e.g., illumination sources 118, 128) to support the data reader and ensure that the respective field-of-view of the data reader is properly illuminated for optimizing the image data capture.

At step 1008, once the image data of the read region has been obtained, the processor 135 (and/or other suitable modules of the data reader in communication therewith) receives and analyzes the image data. Depending on the image-processing settings of the data reader, the processor 135 (and/or other suitable modules) may attempt to decode an optical code (or obtain other target data) from the image data or may implement advanced image analysis techniques to identify the item, verify the item, or take other suitable action depending on the programmed parameters of the data reading system. The processor 135 may employ any one of various suitable image analysis techniques configured for identifying the item, including SIFT (Scale-Invariant Feature Transform) or SURF (Speeded Up Robust Features) methods or other suitable methods.

If the processor 135 (and/or other suitable modules) successfully obtains the target data (e.g., optical code or other data) from the image data, such as by decoding the optical code or successfully identifying the item, the above-referenced steps may be repeated, with the first spatial light modulator in an active state to accommodate the data reader obtaining image data via the first field-of-view. If the processor 135 (and/or other suitable modules) fails to obtain the target data from the capture image data, the method 1000 may continue to step 1010.

At step 1010, the processor 135, and/or other suitable component(s) that may be in communication with the processor 135, deactivates the first spatial light modulator to block light transmission therethrough. At step 1012, the processor 135 activates the second spatial light modulator to allow light to pass therethrough. At step 1014, the single data reader captures image data of a read region through a second field-of-view of the data reading system, wherein the second field-of-view includes light passing through the second spatial light modulator. At step 1016, once the image data of the read region has been obtained through the second field-of-view, the processor 135 (and/or other suitable modules of the data reader in communication therewith) receives and analyzes the image data. Depending on the image-processing settings of the data reader, the processor 135 (and/or other suitable modules) may attempt to decode an optical code (or obtain other target data) from the image data or may implement advanced image analysis techniques to identify the item, verify the item, or take other suitable action depending on the programmed parameters of the data reading system.

In some embodiments, the method 1000 may continue to step 1010 regardless of whether the target data was successfully obtained from the image data at step 1008. In other words, the method 1000 may involve toggling the first and second light modulators between active and inactive states to allow the data reader to obtain image data through the first and second fields-of-view in a continuous cycle. In other embodiments, regardless of whether a read was successful or not after step 1016, the method 1000 may return back to step 1002 to repeat the steps either to reprocess the item that was not successfully read or to proceed with processing a new item.

In some embodiments, the first field-of-view and the second field-of-view described in method 1000 may extend through the same scan window, such as for a single-plane data reading system as described with reference to FIGS. 7-9. In other embodiments, the first field-of-view may instead extend through a first scan window and the second field-of-view may extend through a second scan window, such as for a dual-plane or bioptic data reading system as described with reference to FIGS. 4-6. In still other embodiments, the data reading system may include multiple fields-of-view that may extend through a single scan window or through multiple scan windows as described previously with reference to the disclosed embodiments.

In some embodiments, the method 1000 may be altered depending on the selected spatial light modulator used in the data reading system. For example, the method 1000 described herein is provided in the context of multiple light valves (or the like) used as the spatial light modulators. A data reading system that instead employs a digital micromirror device as the spatial light modulator (as described with reference to FIGS. 6-7) may replace steps 1002, 1004 in the method 1000 as follows: at revised step 1002, configuring a first micromirror array of the spatial light modulator to a first rotational position and, at revised step 1004, configuring a second micromirror array of the spatial light modulator to a second rotational position. This combination of steps achieves the goal of controlling the field-of-view through which the data reader captures the image data at step 1006 (as described with reference to FIGS. 6-7). In a similar fashion, steps 1010 and 1012 of the method 1000 are also adjusted to present the second field-of-view to the data reader. In particular, at revised step 1010, the first micromirror array of the spatial light modulators is configured to a third rotational position and, at revised step 1012, the second micromirror array of the spatial light modulator is configured to a fourth rotational position. The remaining steps of method 1000 continue in the same fashion as described above to obtain and process the image data.

As illustrated in FIG. 10, the method 1000 provides a streamlined approach for optimizing the use of a single data reader with multiple fields-of-view for capturing and obtaining target data from an item. As described, the method 1000 is designed to cycle between the fields-of-view either through a single scan window or multiple scan windows of the data reading system to facilitate the data reading process while minimizing the number of data readers in the data reading system.

It should be understood that in other embodiments, certain steps described in method 1000 of FIG. 10 or features and components described with reference to the disclosed embodiments may be combined, rearranged, altered, varied, and/or omitted without departing from the principles of the disclosed subject matter. It is intended that subject matter disclosed in one portion herein can be combined with the subject matter of one or more of other portions herein as long as such combinations are not mutually exclusive or inoperable. In addition, many variations, enhancements and modifications of the systems and methods described herein are possible.

The terms and descriptions used above are set forth by way of illustration only and are not meant as limitations. Those skilled in the art will recognize that many variations can be made to the details of the above-described embodiments without departing from the underlying principles of the invention.

1. A data reading system comprising:
a housing having a read region;
a data reader supported within the housing, the data reader having a first field-of-view and a second field-of-view each of which directed toward the read region, wherein the data reader is operable to capture image data associated with an item as the item passes across the read region of the housing;
one or more light modulators disposed along an optical path of one or both of the first field-of-view and the second field-of-view; and
a processor in communication with each of the one or more light modulators, the processor configured to operate each of the one or more light modulators to control whether the data reader captures image data associated with the item via only one of the first field-of-view or the second field-of-view at a given time.

2. The data reading system of claim 1, wherein the housing further includes a first scan window disposed along a first section of the housing and a second scan window disposed along a second section of the housing, and wherein the first field-of-view is directed through the first scan window and the second field-of-view is directed through the second scan window.

3. The data reading system of claim 1, wherein the housing further includes a scan window disposed along a first section of the housing, and wherein each of the first field-of-view and the second field-of-view is directed through the scan window.

4. The data reading system of claim 1, wherein the one or more light modulators includes a first light valve and a second light valve, each of which configured to control a level of illumination that passes therethrough when set to a first state and when set to a second state.

5. The data reading system of claim 4, wherein the first light valve is arranged along a first optical path of the first field-of-view and wherein the second light valve is arranged along a second optical path of the second field-of-view, and wherein the processor is operable to set the first light valve at one of the first state or the second state and set the second light valve at the other of the first state or the second state to control whether the data reader captures image data associated with the item via the first field-of-view or the second field-of-view.

6. The data reading system of claim 5, further including a one-way mirror having a reflective surface and an opposite transmissive surface, wherein when the first light valve is set to the first state and the second light valve is set to the second state, the first field-of-view reflects off the reflective surface of the one-way mirror and is focused on the data reader.

7. The data reading system of claim 5, further including a one-way mirror having a reflective surface and an opposite transmissive surface, wherein when the first light valve is set to the second state and the second light valve is set to the first state, the second field-of-view passes through the transmissive surface of the one-way mirror and is focused on the data reader.

8. The data reading system of claim 1, wherein the processor is further configured to operate the one or more light modulators to cyclically alternate the image data capture by the data reader between the first field-of-view and the second field-of-view.

9. The data reading system of claim 8, further comprising one or more illumination assemblies supported within the housing, wherein the processor is further operable to pulse the one or more illumination assemblies to synchronize illumination of the corresponding first field-of-view and the second field-of-view through which the data reader captures the image data.

10. The data reading system of claim 1, wherein the one or more light modulators includes a digital micromirror device operable to selectively reflect one of the first field-of-view or the second field-of-view to the data reader and the other of the first field-of view or the second field-of-view to the data reader away from the data reader at a given time.

11. The data reading system of claim 10, wherein the digital micromirror device is operable to alternate between reflecting the first field-of-view to the data reader and reflecting the second field-of-view to the data reader.

12. A method of data reading via a data reading system, the method comprising:
activating, via a processor, a data reader supported within a housing, the data reader having a first field-of-view and a second field-of-view each of which is directed toward a read region of the data reader;
operating, via the processor, one or more light modulators disposed along an optical path of one or both of the first field-of-view and the second field-of-view;
capturing, via the data reader, image data associated with an item via one of the first field-of-view or the second field-of-view as the item passes across the read region, wherein:
when the processor sets the one or more light modulators to a first operating condition, the data reader captures the image data via the first field-of-view, and
when the processor sets the one or more light modulators to a second operating condition, the data reader captures the image data via the second field-of-view.

13. The method of claim 12, wherein the first field-of-view is directed through a first scan window supported on the housing of a bioptic scanner and the second field-of-view is directed through a second scan window supported on the housing.

14. The method of claim 12, wherein both the first field-of-view and the second field-of-view are each directed through one scan window supported on the housing of a single plane scanner.

15. The method of claim 12, wherein the one or more light modulators includes a first light valve and a second light valve, and wherein the first operating condition further includes setting the first light valve to a first state whereat the first light valve controls a first level of illumination that passes therethrough and setting the second light valve to a second state whereat the second light valve controls a second level of illumination that passes therethrough.

16. The method of claim 15, wherein the second operating condition further includes setting the first to the second state whereat the first light valve substantially blocks light transmission therethrough and setting the second light valve to the first state whereat the second light valve transmits light therethrough.

17. The method of claim 12, further comprising cyclically setting, via the processor, the one or more light modulators between the first operating condition and the second operating condition.

18. The method of claim 12, further comprising one or more illumination assemblies supported within the housing, the method further comprising pulsing, via the processor, the one or more illumination assemblies to synchronize illumination of the first field-of-view when the data reader captures the image data therethrough and to synchronize illumination of the second field-of-view when the data reader captures the image data therethrough.

19. The method of claim 12, wherein the one or more light modulators includes a digital micromirror device, the method further comprising:
reflecting, via the digital micromirror device, the first field-of-view to the data reader when the digital micromirror device is set to the first operating condition; and
reflecting, via the digital micromirror device, the second field-of-view to the data reader when the digital micromirror device is set to the second operating condition.

20. The method of claim 19, further comprising cyclically setting, via the processor, the digital micromirror device between the first operating condition and the second operating condition.
